(19) United States
(12) Patent Application Publication
(10) Pub. No.: US 2023/0414975 A1
(43) Pub. Date: Dec. 28, 2023

(54) METHOD AND APPARATUS FOR MAINTAINING AIRFLOW IN A POWERED AIR PURIFYING RESPIRATOR IN HIGH MAGNETIC FIELDS

(71) Applicant: 3M INNOVATIVE PROPERTIES COMPANY, St. Paul, MN (US)

(72) Inventors: Kenneth J. Krepel, Plymouth, MN (US); Douglas D. Jensen, Woodbury, MN (US); James F. Poch, New Richmond, WI (US); Dale M. Bissen, Woodbury, MN (US); Michael L. Parham, Marine on St. Croix, MN (US)

(21) Appl. No.: 18/252,952

(22) PCT Filed: Nov. 10, 2021
(86) PCT No.: PCT/IB2021/060422

§ 371 Date: May 15, 2023

Related U.S. Application Data
(60) Provisional application No. 63/114,100, filed on Nov. 16, 2020.

(51) Int. Cl. A62B 18/00; A62B 18/02; A62B 18/04; A62B 18/08

(52) U.S. Cl. CPC A62B 18/006; A62B 18/02; A62B 18/04; A62B 18/08

(57) ABSTRACT

A blower/filtration unit for a powered air purifying respirator (PAPR) is presented that includes a motor configured to operate in a standard mode and in a high magnetic field (HMF) mode. The unit also includes a magnetic field sensor. The unit also includes a controller comprising a control mode switching function. The controller executes the control function upon detection of a magnetic field strength that exceeds a reference threshold magnetic field strength. The control function switches the motor operation from the standard mode to the HMF mode.

### BACKGROUND

Powered air-purifying respirators (PAPRs) are fan-forced positive pressure respirators used to provide a user of the PAPR with filtered air. PAPRs generally comprise a mask, blower unit, and a power source. A variety of masks may be employed including hoods, partial face masks and others as known to those of skill in the art. The blower unit includes a motor-driven fan for drawing in ambient air. The ambient air is filtered through one or more filters designed to remove any specific contaminant or combination thereof. The filtered air is delivered to the face mask for the user to breath in.

PAPRs are used in a variety of environments that contain airborne contaminants that may be harmful to humans such as, for example, particulates and/or organic gases and vapors. The use of PAPRs is widespread throughout a large variety of environments including, for example, general industry, healthcare, mining, and smelting.

### SUMMARY

A blower/filtration unit for a powered air purifying respirator (PAPR) is presented that includes a motor configured to operate in a standard mode and in a high magnetic field (HMF) mode. The unit also includes a magnetic field sensor. The unit also includes a controller comprising a control mode switching function. The controller executes the control function upon detection of a magnetic field strength that exceeds a reference threshold magnetic field strength. The control function switches the motor operation from the standard mode to the HMF mode.

### BRIEF DESCRIPTION OF THE DRAWINGS

FIG. 1 is a perspective view of a typical PAPR shown being worn by a user.

FIG. 2 is a perspective and diagrammatic view of a typical PAPR.

FIG. 3 is a perspective view of an embodiment of a blower/filtration unit for a PAPR.

FIG. 4 is a control schematic of the system of FIG. 3 according to an embodiment of the invention.

FIG. 5 is a flow chart of the system of FIG. 4.

FIG. 6 illustrates a constant speed calibration curve scenario implemented in some embodiments herein.

FIG. 7 illustrates a raised speed calibration curve scenario implemented in some embodiments herein.

FIG. 8 illustrates a gradual step calibration curve scenario implemented in some embodiments herein.

FIG. 9 illustrates a calculated step up calibration curve scenario implemented in some embodiments herein.

FIG. 10 illustrates a pressure-based calibration scenario in some embodiments herein.

FIG. 11 illustrates a PAPR that may be used in embodiments herein.

FIG. 12 illustrates a method of maintaining compliant airflow in a PAPR in accordance with embodiments herein.

FIG. 13 illustrates an industrial environment in which embodiments herein may be particularly useful.

### DETAILED DESCRIPTION

As used in this description, the following terms have the meanings as indicated: “User” is a person who interacts with the PAPR either by wearing and/or making any adjustment to the PAPR.

“Ambient magnetic field strength (ambient MF)” means any magnetic field strength that is below a magnetic field strength that interferes with the function of mechanical and/or electronic equipment. Such magnetic field strength may be the measured strength of an actual magnetic field in an environment or an estimated magnetic field strength value (based on known effects of magnetic fields on mechanical and/or electronic equipment).

“High magnetic field strength” (abbreviated as “HMF strength”) means any magnetic field strength at which the function of mechanical and/or electronic equipment may be impaired due to the influence of the magnetic field.

“Threshold magnetic field” (threshold MF) is a magnetic field strength that defines the boundary between an ambient magnetic field strength and a high magnetic field strength as those terms are used herein.

“Compliant air flow” is a volumetric air flow that is compliant with any and all pertinent regulations related to air flow in respirators.

Powered air-purifying respirators generate airflow to the breathing space of a user by means of a fan that draws in air. The air is directed through one or more filters before it is delivered to the user. The volume of air delivered to the user is a important consideration, with minimal volumetric quantities required to support adequate respiration and comfort of the user. Regulatory bodies promulgate various regulations related to PAPRs and typically mandate minimal airflow requirements. Currently, in the United States, NIOSH 42 CFR Part 84 requires loose fitting PAPRs to produce a minimum volumetric air flow of 170 liters per minute (L/min).

Certain factors can affect air flow in a PAPR. For example, as the filter(s) collect contaminants the ease with which air can flow through the filter will be diminished. Thus, higher fan speeds will be required to maintain airflow as filters become loaded or clogged with contaminants. Some PAPRs employ electronics to maintain factory-calibrated airflow at nominal values.

Environmental conditions have also been shown to potentially have a detrimental effect on PAPR performance. A particular challenge is presented when a PAPR is employed in high magnetic field (MF) environments, such as, for example, in the potrooms employed in the smelting process. It has been observed that PAPR airflow rates slow or even stop when the magnetic field strength reaches certain levels due to the adverse effects of the high magnetic field on the function of the motor. Magnetic fields can disrupt a variety of motors that are typically employed in PAPRs. For example, typical brushless DC motors are susceptible to disruption through interference with hall effect sensors. Likewise, sensorless brushless DC motors can have compromised performance due to the interaction of the external magnetic field with the internal field of the motor. Brushed motors may be employed with use of magnetic shielding in some limited range of HMF; however, this approach is not desirable because of the limited lifetime of brushed motors and the limits of MF in which they can perform properly. Magnetic fields may also affect PAPR performance by exerting effects on other components of the motor/blower. For example, impellors made of conductive material may be susceptible to disruption via formation of eddy currents.

The particular and extreme conditions presented in smelting operations (e.g., very elevated temperatures) make use of PAPRs desirable. Therefore, a need exists for overcoming the adverse effects of high magnetic fields on PAPR performance.

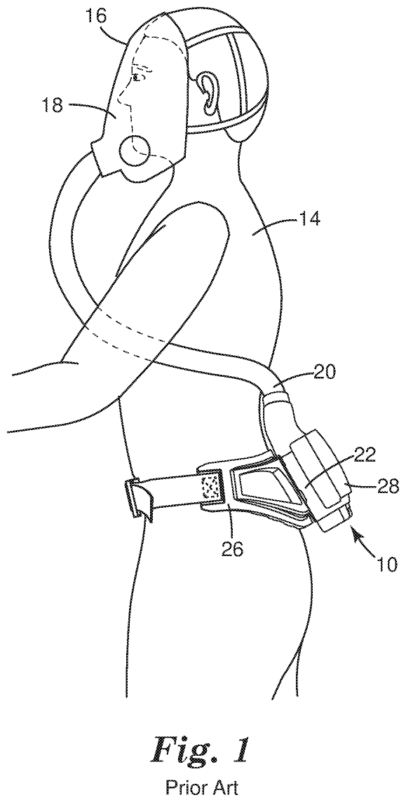

The present invention is directed to a PAPR appropriate for use in high magnetic field strength environments. FIG. 1 depicts a typical prior art PAPR 10 being worn by a user 14. PAPR 10 comprises breathing head gear 16 shown disposed on the face of the user 14 creating a breathing space 18 in which filtered air is supplied through a breathing tube 20 for the user to inspire and into which the user can exhale. Breathing head gear 16 may be a breathing mask, hood, helmet, hard-top, or other suitable component having an inlet for filtered air defining a breathing space 18 for the user. PAPR 10 includes a blower/filter unit 22 that is typically attached to the user 14 via a belt 26 secured about the waist of the user 14. Blower/filter unit 22 is designed to be worn by a user in an atmosphere having unwanted respiratory (and potentially other) contaminants.

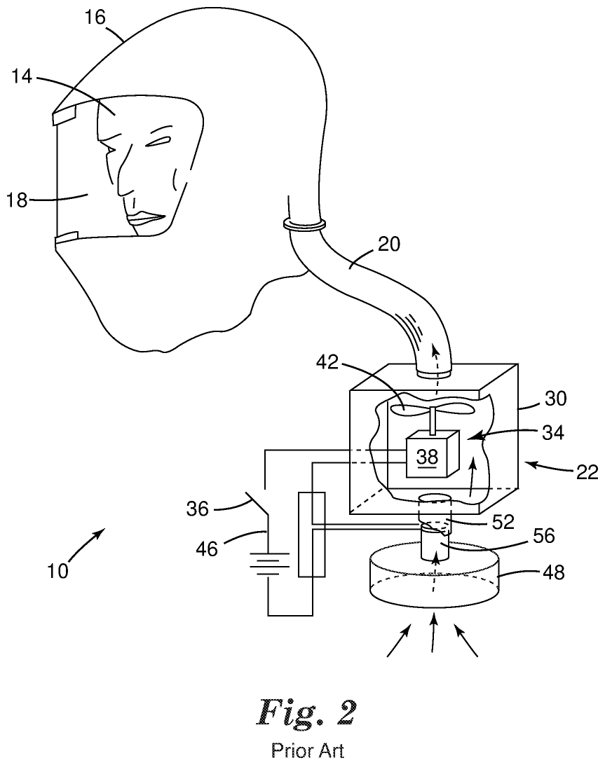

A more detailed view of a typical blower/filter unit 22 is shown in FIG. 2. Blower/filter unit 22 includes a blower housing unit 30 that houses a blower 34. Blower 34 comprises a motor 38 and an impellor 42. Motor 38 is driven by a power source 46 that is typically a battery pack attached to the user (not shown). Blower/filter unit 22 also includes one or more replaceable filter cartridges, canisters, or other filter units 48, a housing fluid (air) inlet 52, and a filter-fluid (air) outlet 56. Blower 34 is used to create negative pressure in a chamber of the blower housing unit 30, which draws air from the ambient environment through one or more more filter cartridge(s) 48 for removing contaminants from the ambient air prior to delivering it via the breathing tube 20 to the breathing space 18 for the user 14 to inhale. The path of air flow is depicted with arrows in FIG. 2.

Blower housing unit 30 may further include electronics and other components directed to maintaining factory-calibrated air flow. Such components include flow control algorithms and motor modulators to control the speed of the motor (not shown).

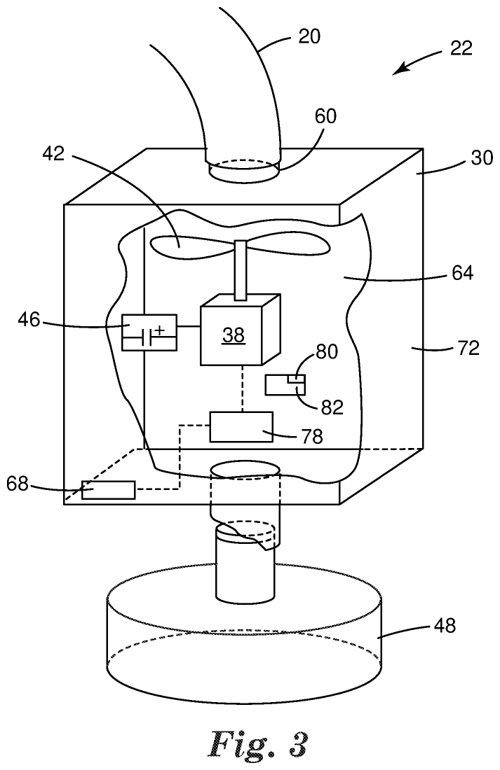

FIG. 3 depicts an embodiment of the blower/filter unit 22 of the present invention. Blower/filter unit 22 includes a blower housing unit 30 that contains a motor 38. Motor may be a brushed motor or brushless motor. In the instance of a brushless motor, motor may be sensored (hall effect sensors) or sensorless. In one embodiment, the motor 38 comprises a brushless direct current (DC) motor (BLDC). Motor 38 drives an impellor 42, which creates negative pressure within a cavity 64 of the blower/filter unit 22 to pull air from the ambient environment through one or more filter cartridges 48. Filtered air is then driven through a breathing tube 20 that is fluidly coupled to the blower/filter unit 22 via a housing fluid (air) outlet 60. Filtered air is then delivered to the breathing space of the breathing head gear (not shown).

According to one embodiment, blower/filter unit 22 includes a magnetic field sensor (MF sensor) 68 for detecting magnetic field strength, such as, for example, a magnetometer. MF sensor 68 may be provided within the blower housing unit 30. Alternatively, MF sensor 68 may be provided on an external surface 72 of the blower housing unit 30. MF sensor 68 may be placed at any location so long as it is able to detect the magnetic field strength of the environment in which the user is located. For example, MF sensor may be provided separate from blower/filter unit 22 and attached to the person of the user, for example, on clothing, PAPR belt, or breathing head gear. Any MF sensor suitable for detecting magnetic field strength may be employed.

In some embodiments, magnetic field sensor 68 is a magnetometer. Magnetometer 68 may be a scalar magnetometer, alternatively magnetometer may be a vector magnetometer. In some embodiments, magnetometer 68 is a three-axis magnetometer. Magnetometers are well known in the art and may be configured in a variety of manners suitable for use in the present inventive PAPR. Magnetic field sensor 68 may also be a reed switch or other magnetically actuated device.

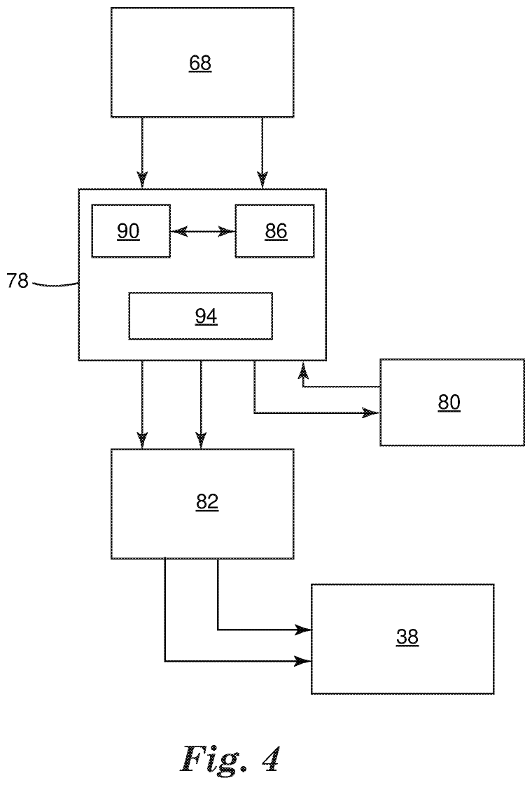

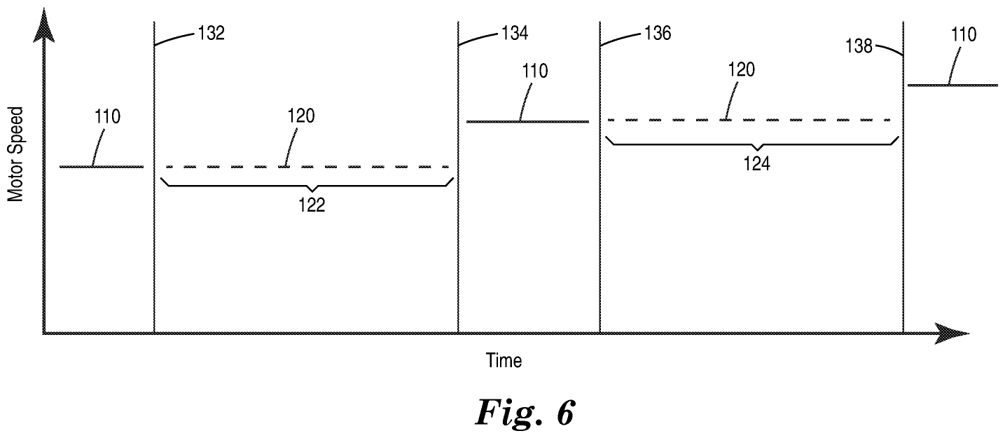

Magnetic field sensor 68 is operatively coupled to an electronic process controller 78, (detailed in FIG. 4) which may comprise various circuitry, memory, software, and the like. Electronic process controller 78 may comprise functions for controlling air flow (air flow control function) to the breathing space of the breathing head gear (not shown in FIG. 3). In some embodiments, electronic process controller 78 comprises air flow control circuitry (not shown) for executing a control function to maintain compliant air flow through the PAPR. The flow function may be, in one embodiment, a constant flow function which maintains a constant air flow by maintaining the motor at a certain predetermined speed (revolution per minute RPM) as long as the system pressure remains constant. The control function controls motor speed according to predetermined calibration parameters, in which motor speed may fluctuate dependent upon certain signals received by the electronic process controller. Such calibrated flow functions are known to those of skill in the art. Electronic process controller 78 operates responsive, in part, to input by MF sensor 68. Electronic process controller 78 determines which air flow control function to execute based on input from MF sensor (discussed in greater detail below). Different calibration flow function options are described in greater detail with respect to FIGS. 6-9 below.

In an embodiment, such air flow control circuitry may operate by employing a motor controller 82. Motor controller 82 is thus operatively coupled to electronic process controller 78. In an embodiment, electronic process controller 78 is configured to send input to motor controller 82 and also to receive input from motor controller 82. Motor controller 82 is configured to relay a motor speed signal to the electronic process controller, which is configured to receive, and in some embodiments, to store such input data. Motor controller 82 may include a motor speed sensor 80. Motor speed sensor may be contained within motor controller (as shown in FIG. 3). Alternatively, motor speed sensor 80 may be independent of motor controller in which case it would be operatively coupled to the electronic process controller 78 either directly or through the motor controller 82. Other signals may also be generated and relayed by the motor controller 82.

Electronic process controller 78 is configured to relay a motor voltage signal to the motor controller, which is configured to receive such a signal. Motor controller 82 is responsive to motor voltage signals generated by the electronic process controller 78 and modulates the motor speed in accordance with such signals. Electronic process controller 78 may generate and relay other signals to the motor controller 82.

Motor controller 82 is operatively coupled to motor 38, which is configured to receive and respond to input signals from motor controller 82. Such signals may include motor voltage signals to control the speed of the motor. Motor 38 may be capable of receiving and responding to various other input signals as well.

FIG. 4 is a control schematic of an embodiment of the PAPR 10 of the present invention. In one embodiment, an electronic process controller 78 is operatively coupled to a motor 38 via a motor controller 82. Motor controller 82 includes a function that controls the speed of the motor 38 and hence the volume of air delivered to the breathing space 18 (not shown). The speed of the motor is determined by the electronic process controller 78 according to computations made by electronic process controller 78, which, in turn, are based on inputs received from MF sensor 68. Inputs from MF sensor 68 are compared to a reference threshold magnetic field that is stored within memory 86 by a comparator 90. Electronic process controller 78 selects an appropriate air flow (motor speed) control function 94, for example from those described in FIGS. 6-9, based on result of the comparison made by the comparator 90 and relays signals appropriate to control motor speed (for example voltage signals) to the motor 38. As will be detailed below, certain air flow functions are based on readings made by motor speed sensor 80 that are relayed to and stored by electronic process controller 78.

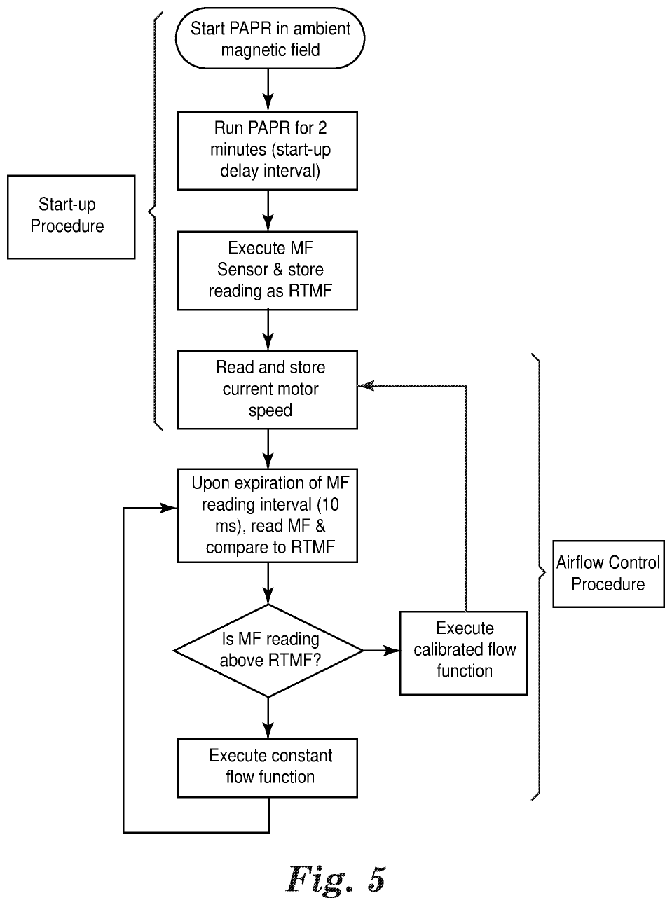

The method of air flow control will now be described with reference to FIG. 5, which illustrates a flow chart of the operation of an embodiment of the PAPR of the present invention. The operation of the PAPR 10 will be described in the context of a smelting operation, during which magnetic fields strong enough to negatively affect PAPRs may be to generated. It will be appreciated that such operation description is for illustrative purposes only and PAPR 10 may be used in other operations (including those in which normal magnetic field strengths are expected). Likewise, any time intervals, values, etc. described are illustrative only and can be modified without departing from the scope of the current invention.

Industrial production of aluminum is typically carried out by an electrolytic process in production plants (smelters). Electrolysis cells are arranged in a series to form a cell line (potline) within a potroom. Currents passed through the cells may be as high as 600,000 amperes, which generates magnetic field strengths well above ambient magnetic field strengths. As used herein, ambient magnetic field strength (AMF) means any magnetic field strength(s) that does not pose significant risks to the operation of electronic and/or mechanical devices. Some motors can be affected by magnetic fields strengths as low as 5 mT. Magnetic field strengths in the vicinity of the potlines have been reported to be as high as 100 mT, or higher. Magnetic fields of these magnitudes could render PAPRs inoperable by disrupting the calibration, rendering loss of airflow below minimum acceptable level due to the tendency of such magnetic field strengths to slow or stop motors.

The present PAPR and method can circumvent adverse effects of high magnetic field strengths on PAPR function. In employing certain embodiments of the present PAPR and methods of the present invention, a user, while in an ambient magnetic field (such as designated rest areas or other areas of smelter in which effects of the magnetic fields produced by cells is negligible) initiates (turns on) the PAPR 10, i.e., initiates electronic process controller 78 and any software, circuitry, functions, etc. that it may contain.

Upon initiation, PAPR 10 commences a start-up procedure. Initiation of PAPR 10 also signals motor 38 to run at speeds sufficient to produce compliant air flow to the breathing space 18 at least as high as those required by pertinent regulatory requirements, e.g., 170 L/min in accordance with current NIOSH regulations. Upon initiation, PAPR 10 may execute any factory-set flow control function, such as those described in FIGS. 6-9 described below to achieve compliant volumetric airflow. Regardless of the flow control that is run, it must reach and maintain a volumetric airflow that is at least equivalent to those required by pertinent regulations.

In some embodiments, after a specific time interval (start-up delay interval), the MF sensor 68 executes and measures the ambient field strength and stores such value in a memory portion of the electronic process controller 78 as a threshold magnetic field strength (TMF). The start-up delay time interval may be a factory pre-set value. In some embodiments, as depicted in FIG. 5, the start-up delay time interval is about two minutes. In other embodiments, a different time interval may be selected. For example, in some embodiments, the start-up delay is only one minute. It will be appreciated that any suitable time interval may be selected. In some embodiments, the interval may be selected by a user from a set of pre-programmed time intervals or be completely customizable, allowing user to enter their desired time interval. In other embodiments, the sensor may be initiated manually by a user. In some embodiments, the start-up delay time interval ranges from about 5 ms to about 10 minutes. In the embodiment depicted in FIG. 5, the start-up delay time interval is about 2 minutes. As will be appreciated, in embodiments employing a factory pre-set, pre-set may comprise a single value or number of values selectable by a user through a user interface (not shown).

In other embodiments, the reference threshold magnetic field strength may be provided as a factory pre-set value or manually selected and entered into the PAPR 10 by a user. Regardless of the method by which the reference threshold magnetic field strength is obtained (read by sensor, factory pre-set, or user entered), it should correspond to a magnetic field strength that is lower than those magnetic field strengths known to impair PAPR motor function.

Start-up procedure further includes collection of the current motor speed. Such motor speed is stored in memory as a reference motor speed (RMS). As will be appreciated, when PAPR 10 is initiated it executes flow control necessary to generate compliant air flow. Thus, since start-up procedure is executed while the PAPR 10 is in an ambient magnetic field, the reference motor speed is the speed that is necessary to generate compliant airflow at the filter's current load/clogging level. In all embodiments, the reference motor speed is the motor speed necessary to generate airflow to breathing space adequate to comply with pertinent regulatory standards. Thus, for embodiments in which the reference threshold magnetic field strength is pre-set or user selected, it will be necessary to run PAPR 10 in ambient magnetic field prior to entering the high magnetic field area to obtain the reference motor speed.

Once PAPR 10 has completed the start-up procedure, an airflow control procedure commences. During airflow control procedure, MF sensor 68 is initiated after a magnetic field reading interval. In some embodiments, MF reading time interval is a factory pre-set value. In other embodiments user may select and enter a desired time interval. In still other embodiments, user selects from multiple interval durations that are factory pre-set. The MF reading time interval, whether factory pre-set or user selected should be of suitable duration taking into consideration that the user's activities and locations are quickly changing.

In some embodiments, the MF sensor time interval ranges from about 10 ms to about 30 seconds. In the embodiment depicted in FIG. 5, the time interval is about 10 ms. Thus, the MF sensor 68 will take a new magnetic field strength reading and relay it to the electronic process controller 78 every 10 ms. During airflow control procedure, PAPR 10 is, in effect, continuously sensing the magnetic field strength.

As described with respect to FIG. 3, electronic process controller 78 includes circuitry, software, functionality, and/or the like to control airflow control. In one embodiment, electronic process controller comprises at least two air control functions; a calibrated flow function, based on stored calibration curves, and a control flow function. As depicted in FIG. 5, the PAPR 10 continuously executes the airflow control procedure to select an appropriate air flow control function dependent upon results of the comparison of the MF reading to the threshold magnetic field.

In some embodiments, once MF reading is taken and relayed to electronic process controller 78, comparator 90 compares the reading to the stored reference threshold magnetic field to determine whether the current magnetic field strength (the MF reading) is above or below the reference threshold magnetic field strength.

As depicted in FIG. 5, if the magnetic field reading is above the reference threshold magnetic field strength, the PAPR 10 executes the constant flow control function and continues to monitor and compare the magnetic field strength conditions at the magnetic field reading interval. PAPR 10 will maintain constant air flow function until magnetic field reading reaches or falls below the reference threshold magnetic field.

When comparator 90 determines that the magnetic field reading is at or below the reference threshold magnetic field, the calibrated air flow function is executed. As can be seen from FIG. 5, down this path, the PAPR 10 will also read and store the current motor speed to obtain an updated reference motor speed to replace the previously stored reference motor speed. PAPR 10 will continuously execute air flow control procedure, acquiring and comparing magnetic field strength readings to the reference threshold magnetic field strength at the magnetic field reading interval (10 ms in the embodiment depicted in FIG. 5). PAPR 10 will maintain calibrated air flow function so long as the magnetic field reading falls below the reference threshold magnetic field strength.

Brushless DC motors offer significant advantages for use in PAPR designs, as they provide efficiency with comfort in a lighter, longer lasting design. However, brushless DC motors experience operational issues when in a high magnetic field environment because of the magnetic circuit inside the motor. Brushed motors may also have similar concerns, too a lesser extent, as brushed designs place the magnetic circuit required for operation deeper in the body of the motor, providing better shielding from external influences. Additionally, depending on the operations being conducted in a high magnetic field area, there may be low, medium, or high particulate presence. The presence of a high magnetic field does not necessarily correlate to a particulate presence or level in an area.

PAPRs that use sensored brushless DC motors will often stop entirely in the presence of a high magnetic field. This is due to the hall effect sensors used to provide commutation signals become overdriven by the high magnetic field

PAPRs that use sensorless brushless DC motor control have a different problem in HMFs in that they will continue to run, but the fan speed slows down considerably. Possibly even below an airflow that is required for respiratory protection, which is an unacceptable outcome.

One potential solution is to fix the motor speed at constant RPM. If there is significant particulate loading on the filter—and as a result the filter pressure drop increases—then locking the motor speed in the HMF will not maintain air flow. Air flow decreases from increasing pressure drop due to filter loading. At some point the system flow will drop below that needed to maintain compliant airflow.

FIGS. 6-9 present different flow function models that may be used to ensure sufficient air flow is provided in a high magnetic field environment. The flow function models of FIGS. 6-9 illustrate different models that may be used to achieve compliant air flow in a PAPR in a high magnetic field where a particulate loading may be high enough to affect airflow.

FIG. 6 illustrates a constant flow scenario implemented in some embodiments herein.

One way to deal with filter loading is to limit the time that the PAPR user spends in HMF flow mode. When the user leaves the HMF environment the blower calibration again becomes effective and the blower can appropriately adjust motor speed and power. A user starts operation in a standard mode 110, prior to entering a high magnetic field mode 120. As illustrated in FIG. 6, in one embodiment, a PAPR maintains a constant motor speed in high magnetic field mode 120, but only for a limited amount of time 122. To establish the maximum time that a user can spend in the HMF environment, an estimated worst-case condition is used. Knowing the worst-case loading condition, a decreased rate of flow can be calculated for a fixed motor speed. A notification or alert can be provided to the user at time 134, requiring them to leave the high magnetic field area.

When the user leaves the high magnetic field area at time 134 (which may be before or at the alert time), a standard calibration, or rebalancing based on the current filter loading, can be done and a motor speed can be re-set to a calibrated rate 110. Once a recalibration is done, the user may reenter the high magnetic field area at time 136, and the motor speed may again be locked for time 124 while the user is in the high magnetic field level. Time 124 may differ from time 122, depending on an anticipated loading rate. However, while a worst-case loading condition was used for time 122, if it is known that a user is re-entering the same HMF area, then time 124 may be calculated based on the known loading rate, or based on a worst-than-known rate for safety concerns.

At time 138, the user again leaves the HMF area, and a calibration is conducted, with the motor speed continuing at the calibrated rate 110. It is noted that the motor does have a maximum speed and if the speed increases close to the max level, an alarm may sound if a user attempts to enter the HMF area again.

The user can leave the HMF environment at any point during allowed times 122, 124. Once out of the HMF environment the PAPR blower will reset to the calibration curve adjusting the motor speed for the existing system pressure, which is based on actual loading of the PAPR filter.

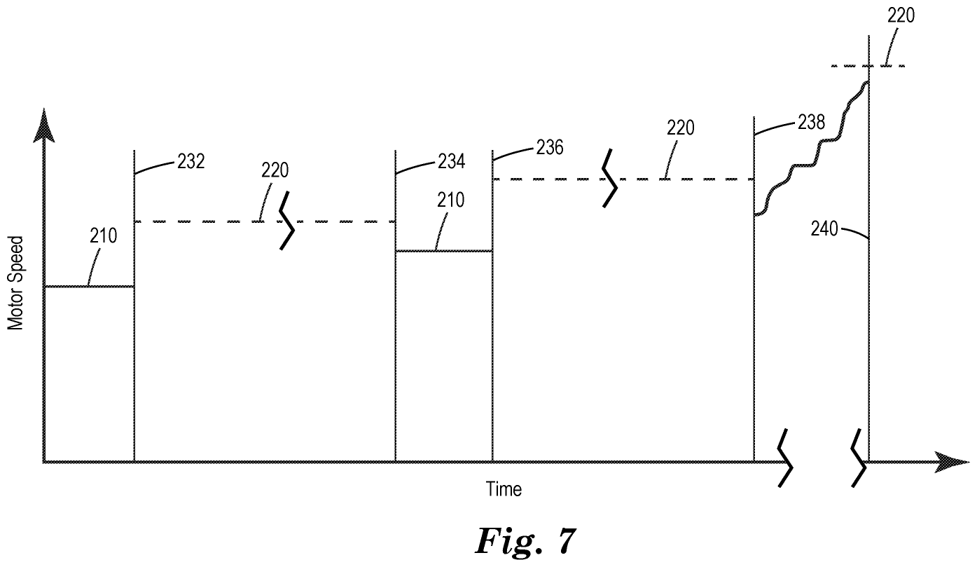

FIG. 7 illustrates a raised flow calibration scenario implemented in some embodiments herein.

The time limit solution of FIG. 6 may be useful in some situations, however in others it may be too short of a time and may place an undue limit on the user's work time. For instance, if the actual particulate loading is less than the worst case, the guidance provided to leave by the time limit would be very conservative and may unduly interrupt the user's work pattern. This could also lead to noncompliance with the provided alerts, which could put the user at risk of injury.

The work time limit can be extended by shifting up a motor speed of the PAPR when entering the HMF environment if the flow rate is set at “standard” or “mid” flow when entering the HMF environment. At “high” flow the initial air flow, in the HMF environment, is at the highest setting and has farther to fall before getting to the minimum flow as filter loading occurs. The motor speed is still locked but it is always locked at the highest flow setting that the product configuration is certified to.

FIG. 7 illustrates an alternative calibration curve scenario that may be implemented in some embodiments herein. In scenario 200, a user first operates their PAPR unit in a standard mode 210. At a time 232 when the PAPR enters a high magnetic field area, the PAPR operates with the motor speed at an elevated rate 220. The elevated rate may be selected based on the highest allowable airflow limit for the PAPR/filter, in some embodiments. For example, if a PAPR operates on a variety of settings, elevated may include adjusting a setting to a next-highest setting from a current setting, or to a highest setting, for example. The elevated rate is selected based on an anticipated loading in the HMF area. The elevated rate may be based on a worst-case scenario anticipated particulate loading. Alternatively, the elevated rate may be based on known information about where the PAPR is or where the user is heading.

As illustrated, when a user leaves an HMF area, at time 234, the motor speed returns to a lower rate based on a standard calibration. Because of loading that may have happened during time 225, the new motor speed at time 234 may be higher than the speed at time 232.

At time 236, the user enters an HMF area and the motor speed increases, giving user a time 225 based on an anticipated rate of particulate loading.

When a user leaves the HMF area at time 238, filter loading proceeds based on the amount of particulates in the air. As illustrated in the time range of time 238-240, the loading may occur at a variable rate, depending on a user's movement patterns within an industrial setting.

At time 240, the user may attempt to enter a HMF area, but the current motor speed is too close to a maximum speed 250. Because of this, an alert may be sent to the user, to a connected cloud datastore, to a safety officer, or to another worker near the user who may be able to intervene.

The work time limit 225 may be specified by a manufacturer, by a user, by a safety officer, or by any other authorized individual. For example, a work time limit of 60 minutes is set, and the elevated motor speed is selected accordingly.

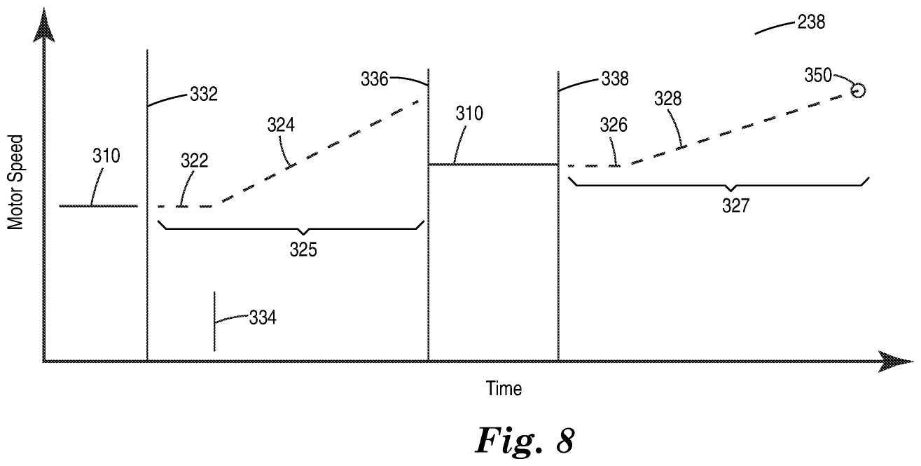

FIG. 8 illustrates a gradual speed increase scenario implemented in some embodiments herein. The calculated time limit that may be implemented in scenario 200 illustrated in FIG. 7 provides an improvement over the working time limit allowed in scenario 100 illustrated in FIG. 6. However, the time limit 225 may still be lower than the user's normal work time. A way to further extend the work time allowed in the HMF is to gradually increase the motor speed to accommodate for loading. Such a method is illustrated in scenario 300.

A user starts operation of their PAPR at a motor speed set by a standard calibration curve 310. At time 332, a user enters a high magnetic field area and a gradual motor speed increase scenario 320 is implemented over a time 325. As illustrated in FIG. 8, at time 332, gradual motor speed increase scenario 320 starts with motor speed at a constant rate 322, which may be the same rate as the standard calibration mode rate 310, may be slightly elevated with respect to rate 310, or may be a step up from rate 310.

Rate 322 is maintained for a portion of time 325, after which a gradual increase 324 in motor speed is initiated until a user leaves the high magnetic field zone at time 336.

The rate 324 of gradual increase of the motor speed can be based on several methods or end points. For example the rate could be based on a work time limit for a user to be in the HMF area, the motor speed at Rate 322 and a known maximum motor speed at end point 350. The minimum work time may have a pre-set default value (e.g. 4 hours). The minimum work time may also be set by the employer. For instance, for safety reasons, they may want the user wearing the PAPR to take a break every 1.5 hours or every 3.5 hours.

At time 336, user leaves HMF area and the motor speed is reset to speed 310 based on a standard calibration. At time 338, when user enters HMF area, the HMF mode is activated and a gradual increase scenario 328 is implemented. As illustrated, in some embodiments a current motor speed 326 is maintained for part of time 327 that the user is in the HMF area, prior to a gradual rate of increase 328 beginning.

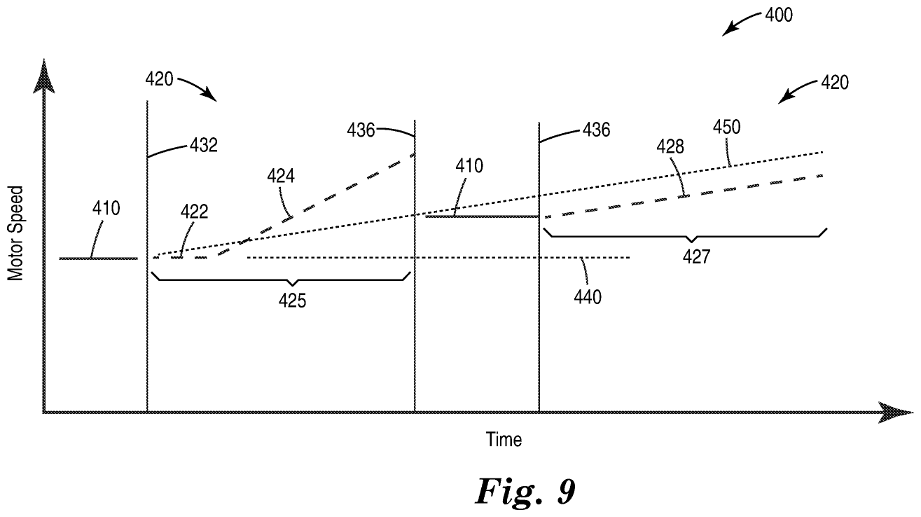

FIGS. 8-9 discuss embodiments where speed of a motor is controlled. However, this is for ease of understanding only. It is expressly contemplated that a voltage could be controlled instead, in some embodiments. This may provide better performance for motors that have better protection from magnetic field interference. This may provide some decoupling of the magnetic influence on the motor and the loading influence on the motor.

In the example of FIG. 8, the end point 350 of motor speed is a maximum motor speed, which may trigger a blower alarm for highest loading. Initial speed 326 is established upon entering the HMF area, and the gradual speed increase rate 328 is based on the initial speed 326, at the maximum motor speed 350, and a minimum work time. The initial motor speed may be held constant for a short, safe, period of time after which the gradual increase would start.

For a user, when particulate loading is actually at the worst-case scenario used for calculating rates 324, 328, the air flow rate within the PAPR remains above the minimum level required. No specific time is set as a limit for time periods 325, 327, instead the motor speed increase accommodates worst case loading and an alarm sounds when a PAPR reaches a maximum blower speed 350.

However, for all instances when loading is less than worst case, the air flow will actually increase. This may be problematic in cases when particulate filter efficiency decreases with increasing air flow. Additionally, for gas and vapor cartridges, the service life would be decreased. If particulate filter efficiency is decreased and/or if cartridge service life is decreased they are decreased in unknown ways since the blower is not specifically controlling air flow while in the HMF area. Therefore, the air flow at any moment in the HMF environment (even though it would be higher than the minimum required flow) is unknown. This makes the available time to work with proper respiratory protection uncertain. Therefore, if at all possible, it is important to use known information about particulate loading rates in an HMF environment.

FIG. 9 illustrates a calculated motor speed increase scenario implemented in some embodiments herein. To overcome the uncertainty of filter efficiency and carbon service life issues described above, a calculated motor speed increase approach can be used as outlined in scenario 400. A standard calibration is used to set an initial motor speed prior to a user entering an HMF area at time 432. At time 432, a calculated control function 420 is initiated. As illustrated in FIG. 9, calculated control function 420 may have an initial period 422 where the motor speed is held constant before it starts to increase at a rate 424.

After a user exits the HMF area at time 434, the PAPR again sets a motor speed based on a calibration curve. A calculation is made for the speed increase curve to be used when the user re-enters the HMF field, at time 434, based on the actual loading experienced during time 425. The calculation may be done, as illustrated in FIG. 9, assuming the actual loading occurred during time 425 as a maximum loading rate, represented by line 450, and as zero loading as a minimum rate 440.

In the scenario illustrated in FIG. 9, every time the user leaves the HMF environment the blower would compare the motor speed from the prior standard mode setting to the present standard mode setting over the time in HMF speed increase to get a measure of the loading rate in the environment. The new HMF mode step up is then calculated based on the loading rate measured from the prior time in HMF mode. This has the advantage of limiting the flow increase while assuring that respiratory protection is maintained.

An alternative to scenario 400 is to have a user enter an HMF area for a test period of time to experience some loading, for example using time 425 as a test period. The user then leaves the HMF area so that a new calculated rate 428 can be obtained based on the known loading rate in the HMF area.

As illustrated, at time 436, when a user re-enters the HMF zone, the motor speed increases at a rate 328 calculated to match the actual loading conditions last experienced for time 427. However, in other embodiments, when a relative loading to be experienced at time 436 is known relative to the loading experienced during time 425, the calculated rate 428 may be adjusted up or down. For example, if a user enters a first HMF area during time 425, and a second area during time 427, a relative particulate loading rate may be known. For example that the area entered at time 436 has roughly twice the loading, or half the loading, as the area experienced during time 425. In such embodiments, the calculated rate 450 may be adjusted upward or downward accordingly.

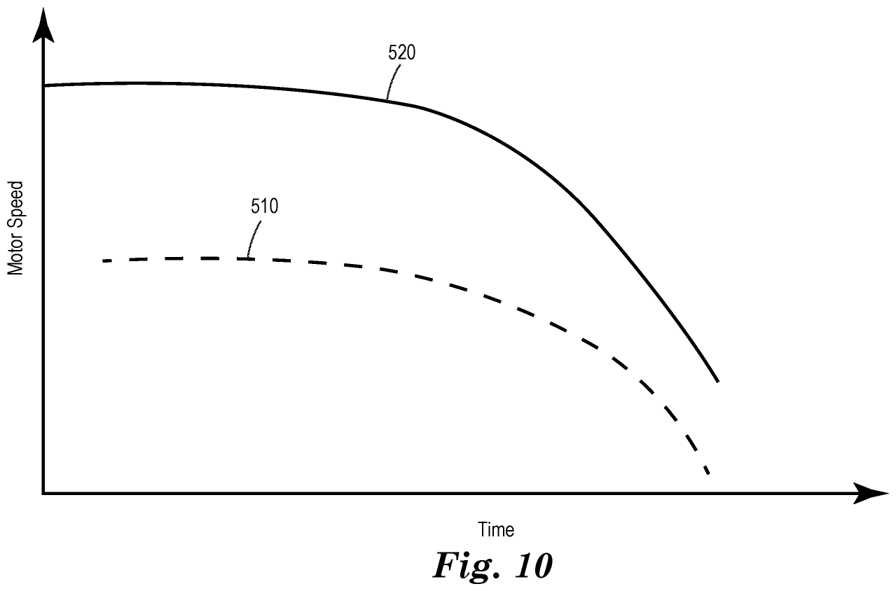

FIG. 10 illustrates a pressure-based calibration scenario implemented in some embodiments herein. When the motor speed is locked at a constant speed in the HMF environment, there is uncertainty as to the actual flow being delivered since the blower does not measure flow directly. FIGS. 6-9 provide several different control algorithms that may be used to increase the likelihood that respiratory protection is maintained by guarding against worst case scenarios. The worst-case scenarios impose time limits for a user to be in the HMF area based on the highest loading scenario. Therefore, since the time limit is based on worst case loading and most loading conditions are not worst case most users actually have more time available—before flow is close to the minimum—than the worst-case time limit allows. One way to overcome relying on the worst-case scenario is to monitor the pressure at the motor-fan inlet by adding a pressure sensor at the fan inlet, where the air leaves the filter and enters the fan. With the motor-fan at constant RPM, the pressure measured will reduce as flow is reduced, as illustrated in FIG. 10 by inlet pressure sensor reading 510 and air flow 520. When the user enters the HMF environment, a microcontroller can record an inlet pressure reading and proceed to monitor the pressure reading while the user is in the HMF environment. If filter loading occurs in the HMF environment—where the motor RPM is held constant—both the flow and the pressure will drop. A correlation between the flow reduction and the pressure reduction is stored in the microcontroller so that the microcontroller can send a notification to the user when the pressure has been reduced to the point where the flow will be just above the minimum.

One difficulty with this approach is that atmospheric air pressure can vary during the time the user is in the HMF environment and this variation could be similar to the pressure change caused by a flow reduction due to filter loading. If this happens the microcontroller would not be able to differentiate the atmospheric changes from filter loading changes. This can be remedied by including a second pressure sensor, outside of the air flow, that monitors only the atmospheric air pressure. The second pressure sensor may be located within the PAPR, or may be remote from the pressure sensor, such that the PAPR receives a signal of ambient atmospheric air pressure. The controller can subtract the momentary atmospheric pressure reading from the momentary inlet pressure reading to remove atmospheric pressure from the inlet pressure readings to get an inlet resultant. The inlet resultant pressure is then used, as described above, to correlate the change in flow due to filter loading.

The microcontroller can alert a user when the air flow from the motor-fan is close to the minimum acceptable value and there is no undue limit of time for the user to remain in the HMF environment.

Using a pressure sensor to substantiate compliant flow allows for any of the control scenarios in FIGS. 6-9 to be modified in-situ to adjust to real-time loading conditions experienced by the PAPR in an HMF area. When the controller calculates that the inlet resultant pressure is dropping, the motor speed can be adjusted accordingly to maintain flow. A correlation may be required to determine a speed increase per resultant pressure decease. Alternatively, if the inlet resultant pressure does not drop, then no adjustment to motor speed is required. By increasing motor speed as inlet resultant pressure drops proper flow is maintained for a longer time period. Thus, a user can stay in the HMF environment for as long as the speed system can maintain proper respiratory protection.

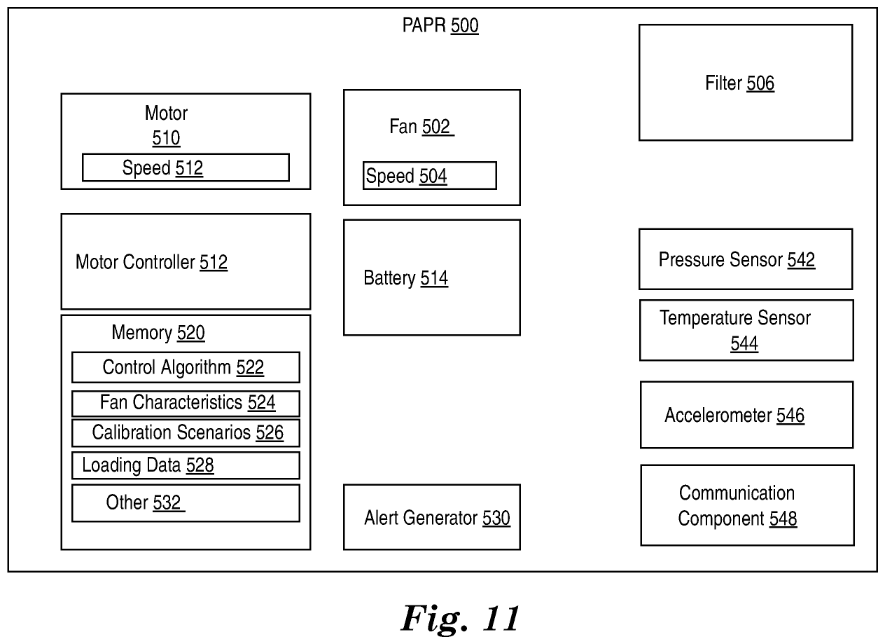

FIG. 11 illustrates a PAPR that may be used in embodiments herein. PAPR 500 may include additional functionality or components not shown in FIG. 11. PAPR 500 includes a filter 506 which may experience particulate loading during operation of PAPR 500.

PAPR 500 includes a fan 502 which operates at a speed 504, driven by motor 510. Motor 510 is controlled by motor controller 512. PAPR 500 is powered by a battery 514. PAPR 500 also includes a memory 520 which, among other things, may store a control algorithm 522 that switches the PAPR between a standard calibration mode of operation and a HMF mode of operation, which may operate using one or more calibration scenarios 526, for example any of those described above with respect to FIG. 6-9. Memory 520 may also store characteristics 524 related to operation of fan 502. Memory 520 may also store loading data 528 for one or more HMF areas. Loading data 528 may be historic or contemporarily received data.

PAPR 500 may also include one or more sensors for receiving ambient environmental information, for example a pressure sensor 542, which may be positioned at a fan inlet and used to more accurately calculate a calibration curve to be used in a calibration scenario 526, for example as described with respect to FIG. 10. PAPR 500 may also have a temperature sensor 544, in some embodiments. PAPR 500 may also have an accelerometer 546 in some embodiments.

PAPR 500 may also have a communication component 548 which may send or receive signals to or from an external source, such as a central hub, another PAPR unit, or another source. For example, instead of having a pressure sensor 542 built in, PAPR 500 may receive an ambient pressure or temperature reading from a remote source, such that sensors 542 and 544 are not needed. Additionally, PAPR 500 may also send a pressure signal to a remote source.

PAPR 500 may also have an alert generator 530 that provides a visual, textual, audio or haptic feedback to a wearer when a motor speed 512 reaches its maximum available speed. Alert generator 530 may also generate an alert provided to communication component 548 which may broadcast the alert to nearby workers, to a central hub, to a safety officer, or to another source which may be able to ensure that a wearer of PAPR 500 leaves an HMF area.

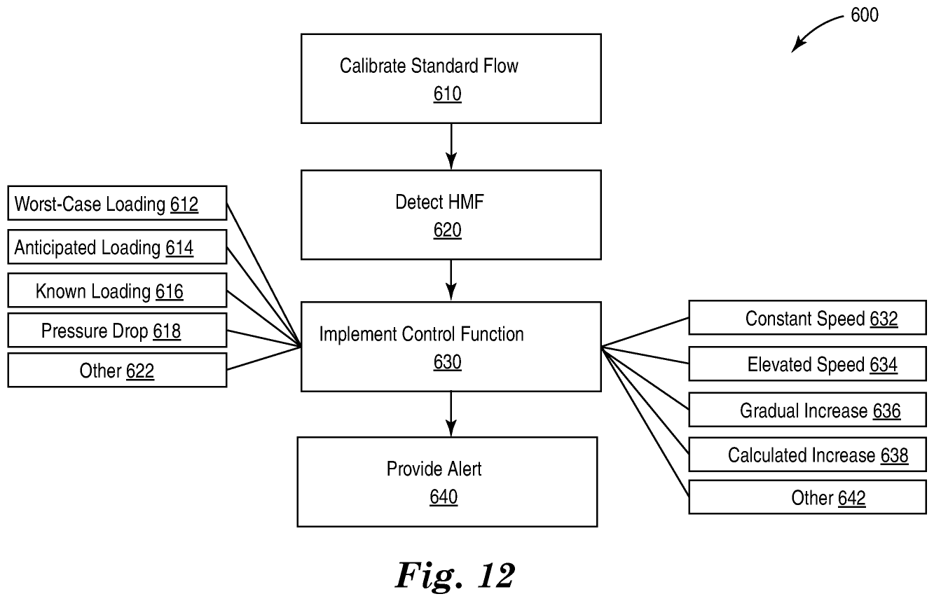

FIG. 12 illustrates a method of maintaining compliant airflow in a PAPR in accordance with embodiments herein. Method 600 may be useful for PAPRs disclosed herein.

In block 610, a standard calibration mode is in operation in a PAPR. The standard calibration mode of operation is based on a current particulate loading of a filter.

In block 620, a high magnetic field is detected. A high magnetic field may be detected by a hall effect sensor or another suitable sensor.

In block 630, when a PAPR enters an area with a high magnetic field, a motor control function is implemented. The motor control function may be implemented based on a worst-case anticipated particulate loading, as indicated in block 612. Alternatively, the motor control function may be implemented based on anticipated loading, as indicated in block 614. For example, a user may be re-entering an HMF area where loading was previously experienced by the PAPR. The controller may be able to anticipate loading to be experienced based on past experience. Alternatively, the motor control function may be implemented based on known loading, as indicated in block 616. For example, PAPRs may be able to communicate with each other, with a hub, and/or with beacons or other measurement tools that can provide an exact indication of particulate loading rates to be expected. Alternatively, the motor control function may be implemented based on detecting a pressure drop 618 indicative of actual loading occurring at the fan inlet.

Implementing a control function may include locking a speed of the motor at a constant rate, as indicated in block 632, in some embodiments. In other embodiments, implementing a control function includes locking a speed of the motor at an elevated rate, as indicated in block 634. In other embodiments, implementing a control function includes gradually increasing a motor speed, as indicated in block 636. In other embodiments, implementing a control function includes increasing a motor speed at a calculated rate, as indicated in block 638. However, other control functions are also contemplated, as indicated in block 642.

In block 640, an alert is provided if an operational constraint of a brushed or brushless motor of the PAPR is met. For example, a battery of the PAPR may be low, or a motor speed may have increased to a maximum speed and may, therefore, no longer be able to provide sufficient airflow. Alerts may be provided for other operational concerns.

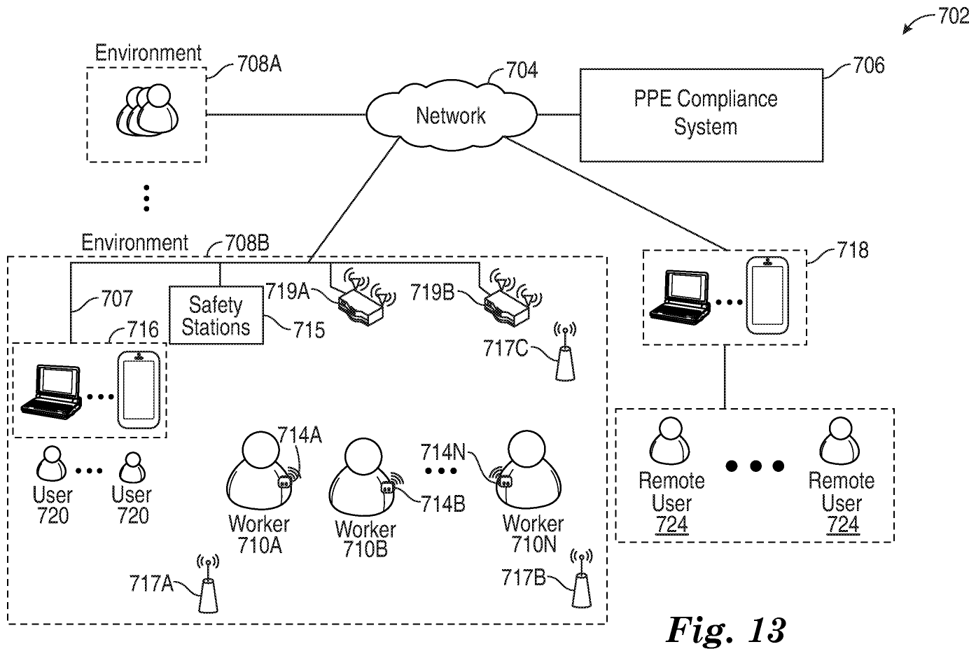

FIG. 13 illustrates an industrial environment in which embodiments herein may be particularly useful. FIG. 13 illustrates a worksite in which embodiments of the present invention may be useful. FIG. 13 is a block diagram illustrating an example network environment 702 for a worksite 708A or 708B. The worksite environments 708A and 708B may have one or more workers 710A-710N, each of which may need to interact with equipment or environments that require the use of a PAPR. Workers 710A-710N may wear a PAPR with a filter that experiences particulate loading. Some areas in environments 708A or 708B may include a high magnetic field that interferes with an ability of a PAPR to accurately detect loading, requiring other methods of maintaining compliant airflow, such as those illustrated in FIGS. 6-9.

Environment includes a communication system 706 which may facilitate communication between PAPRs in environment 708A or 708B. Communication system 706 may receive communication from one PAPR, for example concerning particulate loading in a given HMF area, or an alert about a nearby worker. Central system 706 may also allow safety professionals to review data about particulate loading in different areas of an environment 708A or 708B. Central system 706 may include a database that stores data received from connected PAPRs and/or other PPE about workers, environments 708A and 708B, including particulate loading in different areas, for example.

In general, central system 706, as described in greater detail herein, is configured to receive information from and about environments 708A and 708B. System 706 may be connected, through network 704, to one or more devices or displays 716 within an environment, or devices or displays 718, remote from an environment. System 706 may provide alerts to workers 710A-710N when an allotted safe work time has been reached in an HMF area, for example based on a maximum motor speed being reached or a safe exposure time expiring. System 706 may also be integrated into alarm systems throughout environments 708A, 708B. System 706 may be able to communicate with PAPRs worn by workers in environments 708A, 708B and may be able to track movements of PAPRs. Knowledge of where a PAPR is within environments 708A, 708B may allow for known particulate loading conditions to be determined and communicated to PAPRs for calculating a more accurate motor control algorithm.

As shown in the example of FIG. 13, system 702 represents a computing environment in which a computing device within of a plurality of physical environments 708A, 708B (collectively, environments 708) electronically communicate with central system 706 via one or more computer networks 704.

In some examples, each of environments 708 include computing facilities, such as displays 716, or through associated PPEs, by which workers 710 can communicate with PPE compliance system 706. For examples, environments 708 may be configured with wireless technology, such as 802.11 wireless networks, 802.15 ZigBee networks, and the like. In the example of FIG. 13, environment 708B includes a local network 707 that provides a packet-based transport medium for communicating with PPE computing system 706 via network 704. In addition, environment 708B includes a plurality of wireless access points 719A, 719B that may be geographically distributed throughout the environment to provide support for wireless communications throughout the work environment.

As shown in the example of FIG. 13, an environment, such as environment 708B, may also include one or more wireless-enabled beacons, such as beacons 717A-717C, that provide accurate location information within the work environment. For example, beacons 717A-717C may be GPS-enabled such that a controller within the respective beacon may be able to precisely determine the position of the respective beacon. Alternatively, beacons 717A-717C may include a pre-programmed identifier that is associated in central system 706 with a particular location. Based on wireless communications with one or more of beacons 717, or data hub 714 worn by a worker 710 is configured to determine the location of the worker within work environment 708B. In this way, event data, such as particulate loading data captured at a given time, for example, is reported to central system 706 may be stamped with positional information.

In example implementations, an environment, such as environment 708B, may also include one or more safety stations 715 distributed throughout the environment to provide viewing stations for accessing central system 706. Safety stations 715 may allow one of workers 710 to check out articles of PPE and/or other safety equipment, verify that safety equipment is appropriate for a particular one of environments 708, and/or exchange data. For example, safety stations 715 may transmit alert rules, software updates, or firmware updates to articles of PPE or other equipment.

Safety stations 715 may also provide information about a given PAPR used in an environment 708.

In addition, each of environments 708 include computing facilities that provide an operating environment for end-user computing devices 716 for interacting with central system 706 via network 704. For example, each of environments 708 typically includes one or more safety managers or supervisors, represented by users 720 or remote users 724, who are responsible for overseeing safety compliance within the environment. In general, each user 720 or 724 interacts with computing devices 716, 718 to access central system 706. For example, the end-user computing devices 716, 718 may be laptops, desktop computers, mobile devices such as tablets or so-called smart cellular phones.

Users 720, 724 interact with central system 706 to control and actively manage many aspects of safely equipment utilized by workers 710, such as accessing and viewing usage records, analytics and reporting. For example, users 720, 724 may review compliance information received and stored by system 706. In addition, users 720, 724 may interact with system 706 to review device health information. For example, system 706 may receive information from a temperature sensor regarding device temperature trends, including whether PAPR gets too hot or cold over time. An accelerometer in a PAPR may also indicate whether the device has been dropped, which may indicate that a maintenance check should be performed early. Additionally, information about device events could help predict malfunctions. For example, a blower or fan may degrade or wear over time. Impact data, for example collected from an accelerometer, may provide an indication of rough handling. An accelerometer may also be able to measure vibrations in bearings which may help predict failure.

A battery run down rate may also be inferable by data received from PAPRs over time. PAPR batteries may be able to have a measured internal resistance or may be able to detect and report a change in voltage over time.

Particulate loading rates may also be collectable and analyzed over time and used to better predict future loading trends in different areas. For example, each time a PAPR leaves an HMF area, actual loading information may be obtained and communicated to central system 706. The particulate loading rate in a given area may be used to inform what times to use for FIGS. 6-9. Additionally, such information may be helpful for designing better filters in the future. Additionally, special filters may be usable to determine initial safety risks, for example a filter may have an embedded sensor to assess the loading in different areas of an environment. In some embodiments, a PAPR either has a location identifier, such as GPS or another location identifier, or can be located using beacons in the environments 708.

PAPRs may also provide information about a user, for example body heat trends captured overtime, which may indicated heat-related injury or exhaustion, or over-breathing trends which may indicate a negative pressure. Additionally, as noted in U.S. Provisional Patent Application with Ser. No. 63/072,442, filed on Aug. 31, 2020, additional health-related tracking may be done.

Calibrated flow functions are known in the art and are typically employed in PAPRs to maintain factory calibrated airflow. Calibrated flow functions are able to maintain constant and consistent airflow to the breathing space despite level of filter load/clogging. For example, calibration parameters are employed to modulate motor speed to compensate for decreased airflow that results from the filter becoming filled and clogged with the contaminants filtered out of the ambient air. Calibrated flow functions are suitable for use in ambient magnetic fields, where motor speed will not be affected.

The control functions herein provide an improved ability to maintain constant and consistent airflow but does so, however, by manipulating the motor speed based on anticipated, known, or worst-case loading to generate compliant air flow.

Advantageously, as illustrated in FIGS. 6-9 embodiments herein also contemplate periodically updating the reference motor speed when a PAPR leaves an HMF zone.

As will be appreciated other capabilities may be added to the PAPR 10 without departing from the scope of the present disclosure. For example, additional programming, e.g. hysteresis functions may be included. Likewise, PAPR 10 may include additional components such as air quality monitors. PAPR may also include user interface(s) and/or display screens to display any or all of the parameters already discussed.

A blower/filtration unit for a powered air purifying respirator (PAPR) is presented that includes a motor configured to operate in a standard mode and in a high magnetic field (HMF) mode. The blower/filtration unit also includes a magnetic field sensor. The blower/filtration unit also includes a controller including a control mode switching function. The controller executes the control function upon detection of a magnetic field strength that exceeds a reference threshold magnetic field strength. The control function switches the motor operation from the standard mode to the HMF mode.

The blower/filtration unit may be implemented such that the HMF mode include a control function that operates the motor in any of a constant speed mode, an elevated speed mode, an increasing speed mode or a calculated speed mode. In the constant speed mode the motor operates at a constant speed that is the same as a motor speed at which the motor operated in the standard mode before the control function switched the motor operation from the standard mode to the HMF mode. In the elevated speed mode, the motor operates at an elevated speed which is a faster speed than the motor speed. In the increasing speed mode, the motor operates at an increasing speed that increases at a rate until a maximum motor speed is reached or the detected magnetic field strength no longer exceeds the reference threshold which is based on a worst-case particulate loading estimate. In the calculated speed mode, the motor operates at a calculated speed that increases at a calculated rate until a maximum motor speed is reached or the detected magnetic field strength no longer exceeds the reference threshold. The rate is based on a predicted particulate loading estimate.

The blower/filtration unit may be implemented such that the predicted particulate loading estimate is based on a previous loading rate experienced by the blower/filtration unit.

The blower/filtration unit may be implemented such that the predicted particulate loading estimate is based on a previous loading rate experienced by a second blower/filtration unit.

The blower/filtration unit may be implemented such that the previous loading rate is communicated to the blower/filtration unit through a communication component.

The blower/filtration unit may be implemented such that the previous loading rate is provided from a memory associated with a central system.

The blower/filtration unit may be implemented such that the calculated speed starts at substantially the motor speed.

The blower/filtration unit may be implemented such that the calculated speed maintains substantially the motor speed for a time period before increasing the motor speed at a rate.

The blower/filtration unit may be implemented such that the increasing speed starts at substantially the motor speed.

The blower/filtration unit may be implemented such that in the increasing speed mode, the increasing speed maintains substantially the motor speed before increasing.

The blower/filtration unit may be implemented such that the control mode switching function switches the motor back to standard mode when the detected magnetic field strength no longer exceeds the reference threshold magnetic field strength.

The blower/filtration unit may be implemented such that the threshold magnetic field strength is a measured ambient magnetic field strength.

The blower/filtration unit may be implemented such that the threshold magnetic field is a magnetic field strength value selected from a range of ambient magnetic field strengths.

The blower/filtration unit may be implemented such that the constant flow function maintains the speed of the motor at a motor speed necessary to provide at least 170 L/min of airflow to an air mask when the blower/filtration unit is coupled to the air mask.

The blower/filtration unit may be implemented such that the magnetometer measures magnetic field strength at a predetermined time interval to obtain a measured magnetic field strength.

The blower/filtration unit may be implemented such that it also includes a motor speed detector; and the controller further includes a memory for storing motor speed data.

The blower/filtration unit may be implemented such that the motor speed detector detects the motor speed at a predetermined interval to generate a reference motor speed that is stored by the controller to create a stored reference motor speed. The stored reference motor speed is replaced each time the motor speed is detected.

The blower/filtration unit may be implemented such that the predetermined interval is a time interval or a number of rotations.

The blower/filtration unit may be implemented such that the impellor includes a conductive material.

The blower/filtration unit may be implemented such that the magnetic field sensor is a three-axis magnetometer.

The blower/filtration unit may be implemented such that it includes a housing. The housing includes an air outlet fluidly coupled to an air conduit, the air conduit fluidly coupled to an air mask.

The blower/filtration unit may be implemented such that the HMF mode controls an applied voltage to regulate speed.

The blower/filtration unit may be implemented such that the HMF mode include a control function that operates the motor in any of a constant voltage mode, an elevated voltage mode, an increasing voltage mode or a calculated voltage mode. In the constant voltage mode the motor operates at a constant voltage that is the same as a motor voltage at which the motor operated in the standard mode before the control function switched the motor operation from the standard mode to the HMF mode. In the elevated voltage mode, the motor operates at an elevated voltage that is a higher voltage than the current voltage. In the increasing voltage mode, the motor operates at an increasing voltage. The increasing voltage increases at a rate until a maximum motor voltage is reached or the detected magnetic field strength no longer exceeds the reference threshold. The rate is based on a worst-case particulate loading estimate. In the calculated voltage mode, the motor operates at a calculated voltage. The calculated voltage increases at a calculated rate until a maximum motor voltage is reached or the detected magnetic field strength no longer exceeds the reference threshold. The rate is based on a predicted particulate loading estimate.

A method of maintaining airflow in a powered air-purifying respirator (PAPR) is presented that includes providing a PAPR including a motor, a magnetic field sensor, and a controller, the controller including a high magnetic field (HMF) flow function and a calibrated flow function. The method also includes storing a reference threshold magnetic field strength in the controller. The method also includes reading a motor speed necessary to generate a compliant air flow in an ambient magnetic field environment and storing the motor speed as a reference motor speed. The method also includes periodically reading magnetic field strength and comparing the reading to the reference threshold magnetic field strength. The HMF flow function is executed in response to a magnetic field strength reading that exceeds the reference threshold magnetic field strength and the calibrated flow function is executed in response to a magnetic field strength reading that falls below the reference threshold magnetic field strength.

The method may be implemented such that the HMF flow function operates the motor at a constant speed, or at an elevated speed, or at an increasing speed, or at a calculated speed. The constant speed is the same as a motor speed at which the motor operated under the calibrated flow function. The elevated speed is a faster speed than the motor speed. The increasing speed increases at a rate until a maximum motor speed is reached or the detected magnetic field strength no longer exceeds the reference threshold. The rate is based on a worst-case particulate loading estimate. The calculated speed increases at a calculated rate until a maximum motor speed is reached or the detected magnetic field strength no longer exceeds the reference threshold. The rate is based on a predicted particulate loading estimate.

The method may be implemented such that the predicted particulate loading estimate is based on a previous loading rate experienced by the blower/filtration unit.

The method may be implemented such that the predicted particulate loading estimate is based on a previous loading rate experienced by a second blower/filtration unit.

The method may be implemented such that the previous loading rate is communicated to the blower/filtration unit through a communication component.

The method may be implemented such that the previous loading rate is provided from a memory associated with a central system.

The method may be implemented such that the calculated speed starts at substantially the motor speed.

The method unit may be implemented such that the calculated speed maintains substantially the motor speed before increasing.

The method may be implemented such that the increasing speed starts at substantially the motor speed.

The method may be implemented such that the increasing speed maintains substantially the motor speed before increasing.

The method may be implemented such that the reference threshold magnetic field strength is obtained by reading magnetic field strength while the PAPR is in an ambient magnetic field.

The method may be implemented such that the reference threshold magnetic strength is a value within ambient magnetic field ranges selected by a user.

The method may be implemented such that it includes reading magnetic field strength at a predetermined time interval subsequent to the steps of capturing and storing the reference threshold magnetic field strength.

The method may be implemented such that a magnetic field strength reading at or below the threshold reference magnetic field strength signals the controller to obtain a new motor speed reading and to replace the reference motor speed with the new motor speed reading such that the new motor speed reading becomes the reference motor speed.

The method may be implemented such that magnetic field strength is read and compared to the reference threshold ambient magnetic field strength at a predetermined time interval.

The method may be implemented such that the predetermined time interval ranges from about continuously to about 30 seconds.

A controller for a powered air-purifying respirator (PAPR) is presented that includes a magnetic field strength receiver. The controller also includes a motor speed algorithm that is executed based upon detection that a magnetic field strength proximate the PAPR exceeds a reference threshold magnetic field strength. The motor speed algorithm increases a speed of a motor of the PAPR.

The controller may be implemented such that the motor speed algorithm increases the speed of the motor from a standard mode speed to a high magnetic field strength speed in response to the detected magnetic field strength.

The controller may be implemented such that the high magnetic field strength speed is elevated with respect to the standard mode speed.

The controller may be implemented such that the motor speed algorithm increases the high magnetic field strength speed over time.

The controller may be implemented such that the motor speed algorithm increases the high magnetic field strength speed over time based on a worst case scenario particulate loading rate.

The controller may be implemented such that the motor speed algorithm increases the high magnetic field strength speed over time based on a predicted particulate loading rate.

The controller may be implemented such that the predicted particulate loading rate is based on a previously detected particulate loading rate.

The controller may be implemented such that the motor speed algorithm increases the high magnetic field strength speed over time based on a known particulate loading rate.

The controller may be implemented such that the motor speed algorithm calculates the high magnetic field strength speed based on a received particulate loading indicia.

The controller may be implemented such that the particulate loading indicia is a previously recorded particulate loading rate stored in a memory of the PAPR.

The controller may be implemented such that the particulate loading indicia is received from a second PAPR.

The controller may be implemented such that the particulate loading indicia is received from a central system.

The controller may be implemented such that the received particulate loading indicia is associated with a location of the PAPR.

The controller may be implemented such that the location is identified by a GPS unit associated with the PAPR or a wearer of the PAPR.

The controller may be implemented such that the location of the PAPR is provided by a beacon in the vicinity of the controller.

The controller may be implemented such that the controller also includes a position detector. The magnetic field strength receiver retrieves a magnetic field strength based on a detected position of the PAPR.

A system for maintaining airflow in a powered air-purifying respirator (PAPR) is presented that includes a magnetic field strength sensor that detects a magnetic field strength in an environment and a PAPR. The PAPR includes a magnetic field strength receiver, a motor and a controller that provides a motor speed algorithm to control a motor speed of the motor upon detection of an environmental magnetic field strength that exceeds a reference threshold magnetic field strength.

The system may be implemented such that the magnetic field strength sensor is a stationary environmental sensor that communicates the magnetic field strength to the controller.

The system may be implemented such that the magnetic field strength sensor detects the magnetic field strength in the environment and communicates the detected magnetic field strength to a memory for periodic storage.

The system may be implemented such that a stored magnetic field strength is provided to the PAPR based on a detected location of the PAPR.

The system may be implemented such that the PAPR has an internal position sensor that provides a location of the PAPR to the controller. The controller retrieves a stored magnetic field strength based on the location.

The system may be implemented such that it includes a location indicator that provides a location of the PAPR.

The system may be implemented such that the location of the PAPR is stored in the memory.

The system may be implemented such that the location indicator is a stationary location beacon. The location indicator provides the location when the PAPR is detected near the location beacon.

The system may be implemented such that the motor speed algorithm increases the speed of the motor from a standard mode speed to a high magnetic field strength speed in response to the detected magnetic field strength.

The system may be implemented such that the high magnetic field strength speed is elevated with respect to the standard mode speed.

The system may be implemented such that the motor speed algorithm increases the high magnetic field strength speed over time.

The system may be implemented such that the motor speed algorithm increases the high magnetic field strength speed over time based on a worst case scenario particulate loading rate.

The system may be implemented such that the motor speed algorithm increases the high magnetic field strength speed over time based on a predicted particulate loading rate.

The system may be implemented such that the predicted particulate loading rate is based on a previously detected particulate loading rate.

The system may be implemented such that the motor speed algorithm increases the high magnetic field strength speed over time based on a known particulate loading rate.

The system may be implemented such that the motor speed algorithm calculates the high magnetic field strength speed based on a received particulate loading indicia.

The system may be implemented such that the particulate loading indicia is a previously recorded particulate loading rate stored in a memory of the PAPR.

The system may be implemented such that the particulate loading indicia is received from a second PAPR.

The system may be implemented such that the particulate loading indicia is received from a central system.

The system may be implemented such that the received particulate loading indicia is associated with a location of the PAPR.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1-37. (canceled)

38. A system for maintaining airflow in a powered air-purifying respirator (PAPR) comprising:
a magnetic field strength sensor that detects a magnetic field strength in an environment; and
a PAPR comprising:
a magnetic field strength receiver;
a motor; and
a controller that provides a motor speed algorithm to control a motor speed of the motor upon detection of an environmental magnetic field strength that exceeds a reference threshold magnetic field strength.

39. The system of claim 38, wherein the magnetic field strength sensor is a stationary environmental sensor that communicates the magnetic field strength to the controller.

40. The system of claim 38, wherein the motor speed algorithm increases the speed of the motor from a standard mode speed to a high magnetic field strength speed in response to the detected magnetic field strength.

41. The system of claim 40, wherein the high magnetic field strength speed is elevated with respect to the standard mode speed.

42. The system of claim 40, wherein the motor speed algorithm increases the high magnetic field strength speed over time.

43. The system of claim 40, wherein the motor speed algorithm increases the high magnetic field strength speed over time based on a predicted particulate loading rate.

44. The system of claim 43, wherein the predicted particulate loading rate is based on a previously detected particulate loading rate.

45. The system of claim 44, wherein the motor speed algorithm increases the high magnetic field strength speed over time based on a known particulate loading rate.

46. The system of claim 44, wherein the motor speed algorithm increases the high magnetic field strength speed based on a received particulate loading indicia.

47. A blower/filtration unit for a powered air purifying respirator (PAPR) comprising:
a motor configured to operate in a standard mode and in a high magnetic field (HMF) mode;
a magnetic field sensor; and
a controller comprising a control mode switching function, wherein the controller executes the control function upon detection of a magnetic field strength that exceeds a reference threshold magnetic field strength, and wherein the control function switches the motor operation from the standard mode to the HMF mode.

48. The blower/filtration unit of claim 47, wherein the HMF mode comprise a control function that operates the motor in any of a constant speed mode, an elevated speed mode, an increasing speed mode or a calculated speed mode, and wherein:
in the constant speed mode the motor operates at a constant speed, wherein the constant speed is the same as a motor speed at which the motor operated in the standard mode before the control function switched the motor operation from the standard mode to the HMF mode;
in the elevated speed mode, the motor operates at an elevated speed, wherein the elevated speed is a faster speed than the motor speed;
in the increasing speed mode, the motor operates at an increasing speed, wherein the increasing speed increases at a rate until a maximum motor speed is reach or the detected magnetic field strength no longer exceeds the reference threshold, wherein the rate is based on a worst-case particulate loading estimate; and
in the calculated speed mode, the motor operates at a calculated speed, wherein the calculated speed increases at a calculated rate until a maximum motor speed is reach or the detected magnetic field strength no longer exceeds the reference threshold, wherein the rate is based on a predicted particulate loading estimate.

49. The blower/filtration unit of claim 48, wherein the predicted particulate loading estimate is based on a previous loading rate experienced by the blower/filtration unit.

50. The blower/filtration unit of claim 47, wherein the previous loading rate is communicated to the blower/filtration until through a communication component.

51. The blower/filtration unit of any of claim 47, and wherein the control mode switching function switches the motor back to the standard mode when the detected magnetic field strength no longer exceeds the reference threshold magnetic field strength.

52. The blower/filtration unit of any of claim 47, wherein the HMF mode controls an applied voltage to regulate speed, and
wherein the HMF mode comprise a control function that operates the motor in any of a constant voltage mode, an elevated voltage mode, an increasing voltage mode or a calculated voltage mode, and wherein:
in the constant voltage mode the motor operates at a constant voltage, wherein the constant voltage is the same as a motor voltage at which the motor operated in the standard mode before the control function switched the motor operation from the standard mode to the HMF mode;
in the elevated voltage mode, the motor operates at an elevated voltage, wherein the elevated voltage is a higher voltage than the current voltage;
in the increasing voltage mode, the motor operates at an increasing voltage, wherein the increasing voltage increases at a rate until a maximum motor voltage is reach or the detected magnetic field strength no longer exceeds the reference threshold, wherein the rate is based on a worst-case particulate loading estimate; and
in the calculated voltage mode, the motor operates at a calculated voltage, wherein the calculated voltage increases at a calculated rate until a maximum motor voltage is reach or the detected magnetic field strength no longer exceeds the reference threshold, wherein the rate is based on a predicted particulate loading estimate.

53. A method of maintaining airflow in a powered air-purifying respirator (PAPR) comprising:
providing a PAPR comprising a motor, a magnetic field sensor, and a controller, the controller comprising a high magnetic field (HMF) flow function and a calibrated flow function;
storing a reference threshold magnetic field strength in the controller;
reading a motor speed necessary to generate a compliant air flow in an ambient magnetic field environment and storing the motor speed as a reference motor speed;
periodically reading magnetic field strength and comparing the reading to the reference threshold magnetic field strength;
wherein the HMF flow function is executed in response to the magnetic field strength reading that exceeds the reference threshold magnetic field strength and the calibrated flow function is executed in response to a magnetic field strength reading that falls below the reference threshold magnetic field strength.

54. The method of claim 53, wherein the HMF flow function operates the motor;
at a constant speed, wherein the constant speed is the same as a motor speed at which the motor operated under the calibrated flow function, or
at an elevated speed, wherein the elevated speed is a faster speed than the motor speed; or
at an increasing speed, wherein the increasing speed increases at a rate until a maximum motor speed is reach or the detected magnetic field strength no longer exceeds the reference threshold, wherein the rate is based on a worst-case particulate loading estimate, or
at a calculated speed, wherein the calculated speed increases at a calculated rate until a maximum motor speed is reach or the detected magnetic field strength no longer exceeds the reference threshold, wherein the rate is based on a predicted particulate loading estimate.

55. The method of any of claim 53, wherein a magnetic field strength reading at or below the threshold reference magnetic field strength signals the controller to obtain a new motor speed reading and to replace the reference motor speed with the new motor speed reading such that the new motor speed reading becomes the reference motor speed.
